(19) United States
(12) Patent Application Publication
(10) Pub. No.: US 2013/0129542 A1
(43) Pub. Date: May 23, 2013

(54) MOTOR STRUCTURE OF INTAKE MANIFOLD

(71) Applicants: Dae Sung Park, Hwaseong-si (KR); Jong Hyuck Kim, Hwaseong-si (KR)

(72) Inventors: Dae Sung Park, Hwaseong-si (KR); Jong Hyuck Kim, Hwaseong-si (KR)

(73) Assignee: Hyundai Motor Company, Seoul (KR)

(21) Appl. No.: 13/432,961

(22) Filed: Mar. 28, 2012

(30) Foreign Application Priority Data
Nov. 23, 2011 (KR) 10-2011-0122991

(51) Int. Cl. F04D 25/06; F02M 35/00

(52) U.S. Cl. 417/423.1

(57) ABSTRACT

A motor structure of an intake manifold may include a compressor interlocking with a shaft and mounted on the intake manifold, a first pulley and a belt provided at an end of the shaft, and an electric motor having a motor shaft that may be coupled to a second pulley that may be engaged with the first pulley via the belt, wherein the motor shaft of the electric motor may be selectively coupled to a flywheel that may be additionally provided to pass through the pulley and the belt.

### CROSS-REFERENCE TO RELATED APPLICATION

The present application claims priority to Korean Patent Application No. 10-2011-0122991, filed on Nov. 23, 2011, the entire contents of which is incorporated herein for all purposes by this reference.

### BACKGROUND OF THE INVENTION

1. Field of the Invention

The present invention relates to a motor structure of an intake manifold, and more particularly, to a motor structure of an intake manifold, which provides power to the intake manifold.

2. Description of Related Art

In general, an intake manifold that is used in an engine of a vehicle serves to expedite combustion through distribution of mixed gas of air that flows in through an intake hose and fuel to the inside of each cylinder of the engine.

Recently, the intake manifold is manufactured using a plastic material to reduce the weight of the vehicle. Specifically, several parts of an intake manifold are separately formed, and then are integrally bonded through a method such as welding or the like.

On the other hand, in order for an engine that is an internal combustion engine to start operation, it is necessary to rotate a crank shaft by means of a motor provided outside.

In the related art, a DC series motor has been used for this purpose. However, this type of motor has problems in that it consumes a large amount of electricity and it may not be continuously used for a long time.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a motor structure of an intake manifold, which makes it possible to provide power to the intake manifold.

In one aspect of the present invention, a motor structure of an intake manifold may include a compressor interlocking with a shaft and mounted on the intake manifold, a first pulley and a belt provided at an end of the shaft, and an electric motor having a motor shaft that is coupled to a second pulley that is engaged with the first pulley via the belt, wherein the motor shaft of the electric motor is selectively coupled to a flywheel that is additionally provided to pass through the pulley and the belt.

The motor shaft is relatively movable from or to the electric motor.

A pinion gear is formed at an end portion of the motor shaft of the electric motor, wherein a ring gear is formed on an outer periphery of the flywheel, and wherein the motor shaft of the electric motor and the flywheel are selectively gear-engaged with each other via the pinion gear and the ring gear.

The electric motor interlocks with an electromagnetic switch, wherein a drive lever is provided at an end of the electromagnetic switch, and the drive lever is coupled to the motor shaft of the electric motor.

As described above, according to the present invention, a start motor that is used in the intake manifold is removed, and thus the number of components and the manufacturing cost can be reduced to improve the productivity and merchantability, and the weight of the engine can be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a motor structure of an intake manifold according to an exemplary embodiment of the present invention.

FIG. 2 is a view illustrating the state of a motor structure of an intake manifold during a start operation according to an exemplary embodiment of the present invention.

FIG. 3 is a view illustrating the state of a motor structure of an intake manifold after a start operation.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, preferred embodiments of the present invention will be described with reference to the accompanying drawings.

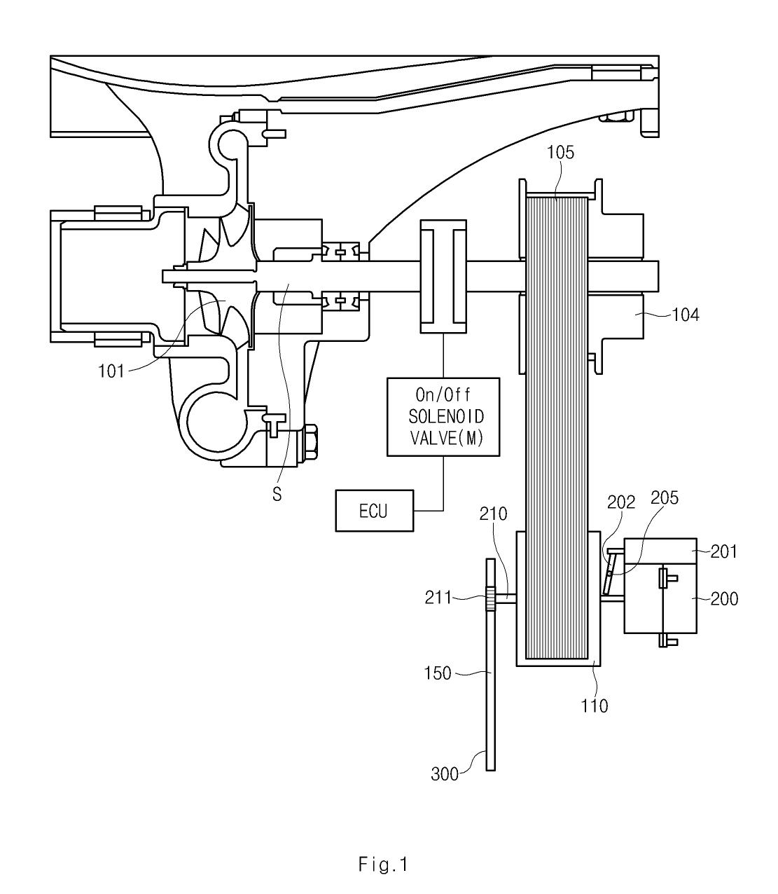

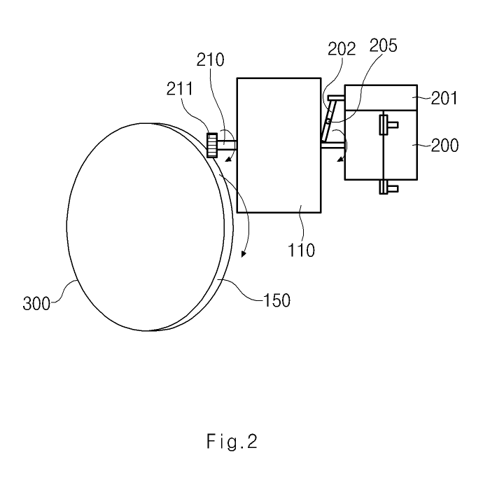

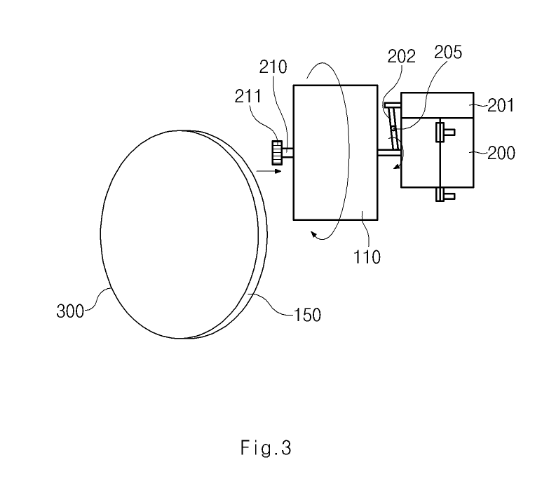

FIGS. 1 to 3 show a motor structure of an intake manifold according to an exemplary embodiment of the present invention. FIG. 1 is a view illustrating a motor structure of an intake manifold according to an exemplary embodiment of the present invention, FIG. 2 is a view illustrating the state of a motor structure of an intake manifold during a start operation according to an exemplary embodiment of the present invention, and FIG. 3 is a view illustrating the state of a motor structure of an intake manifold after a start operation.

As illustrated in FIGS. 1 to 3, according to the basic technical features of the motor structure of the intake manifold according to an exemplary embodiment of the present invention, a shaft S mounted on the intake manifold interlocks with an electric motor 200, and the electric motor 200 has a motor shaft 210 that is detachably coupled to a flywheel 300.

Hereinafter, respective configuration elements of the motor structure of the intake manifold according to an exemplary embodiment of the present invention will be described one by one with reference to the accompanying drawings.

First, as illustrated in FIG. 1, a compressor 101 that interlocks with a shaft S is mounted on the intake manifold, and a pulley 104 and a belt 105 are provided at an end of the shaft S. The pulley 104 and the belt 105 are engaged to an electric motor 200 through a pulley 110.

The electric motor 200 has the motor shaft 210, which is engaged to the pulley 104 and the belt 105 to transfer power.

In this case, the motor shaft 210 of the electric motor 200 is detachably coupled to a flywheel 300 that is additionally provided to pass through the pulley 104 and the belt 105.

On the other hand, a pinion gear 211 is formed at the end of the motor shaft 210 of the electric motor 200, and a ring gear 150 is formed on an outer periphery of the flywheel 300. The motor shaft 210 of the electric motor 200 and the flywheel 300 are selectively gear-engaged with each other to transfer the rotating force.

Here, the motor shaft 210 of the electric motor 200 and the flywheel 300 are detachably coupled to each other, and the motor shaft 210 of the electric motor 200 is provided to move in the forward/backward direction from the electric motor 200. The electric motor 200 interlocks with an electromagnetic switch 201 additionally provided, a drive lever 202 is provided at an end of the electromagnetic switch 201, and the drive lever 202 is engaged to the motor shaft 210 of the electric motor 200.

As described above, according to an exemplary embodiment of the present invention, the power is supplied to the flywheel 300 using the electric motor 200 that drives the compressor 101 installed at the lower end of the intake manifold to start the engine. The motor shaft 210 of the electric motor 200 is extended, and the pinion gear 211 is mounted on the extended shaft 210.

If the electromagnetic switch 201 is operated to drive the drive lever 202, the drive lever 202 moves the motor shaft 210 and thus the pinion gear 211 rotates the ring gear 150, which is formed on the outer periphery of the flywheel 300 and is tooth-engaged with the pinion gear 211, to make it possible to start the engine.

In an exemplary embodiment of the present invention, the motor shaft 210 may be spline-engaged to the pulley 110 and the motor shaft 210 is movable through the pulley 110. In this case, the motor shaft 210 may be configured to move relatively from the electric motor 200 by the drive lever 202.

In another exemplary embodiment of the present invention, the motor shaft 210 and the pulley 110 may be integrally connected. In this case, the pulley 110 and the motor shaft 210 may move relatively from the electric motor 200 by the drive lever 202 as much as the thickness of the pinion gear 211.

In further another exemplary embodiment of the present invention, a mid portion of the drive lever 202 is pivotal about a hinge 205 coupled thereto.

In another exemplary embodiment of the present invention, the other end of the drive lever 202 is rotatably engaged around the motor shaft 210 of the electric motor 200 to push or pull the motor shaft 210.

After the start of the engine, since the electromagnetic switch 201 is turned off, the drive lever 202 is pushed, and the pinion gear 211 moves to be apart from the flywheel 300. Accordingly, the electric motor 200 drives the pulley 104 and the belt 105 to provide the power to the intake manifold.

As illustrated in FIG. 2, during the start operation, the electric motor 200 is rotated, the electromagnetic switch 201 is operated to pull the drive lever 202, and the pinion gear 211 that is tooth-engaged with the ring gear 150 of the flywheel 300 rotates the flywheel 300.

As illustrated in FIG. 3, after the start of the engine, since the engine continues to rotate and the rotating force is applied to rotate the pinion gear 211, the electromagnetic switch 201 is turned off to release the tooth-engagement of the pinion gear 211.

As described above, the motor structure of the intake manifold according to an exemplary embodiment of the present invention includes a compressor interlocking with a shaft and mounted on the intake manifold, a pulley and a belt provided at an end of the shaft as a power transfer means, and an electric motor having a motor shaft that is connected to the pulley and the belt, wherein the motor shaft of the electric motor is detachably coupled to a flywheel additionally provided to pass through the pulley and the belt. Since a start motor that is used in the intake manifold is removed, the number of components and the manufacturing cost can be reduced to improve the productivity and merchantability, and the weight of the engine can be reduced.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A motor structure of an intake manifold comprising:
a compressor interlocking with a shaft and mounted on the intake manifold;
a first pulley and a belt provided at an end of the shaft; and
an electric motor having a motor shaft that is coupled to a second pulley that is engaged with the first pulley via the belt,
wherein the motor shaft of the electric motor is selectively coupled to a flywheel that is additionally provided to pass through the pulley and the belt.

2. The motor structure according to claim 1, wherein the motor shaft is relatively movable from or to the electric motor.

3. The motor structure according to claim 1,
wherein a pinion gear is formed at an end portion of the motor shaft of the electric motor,
wherein a ring gear is formed on an outer periphery of the flywheel, and
wherein the motor shaft of the electric motor and the flywheel are selectively gear-engaged with each other via the pinion gear and the ring gear.

4. The motor structure according to claim 1,
wherein the electric motor interlocks with an electromagnetic switch,
wherein a drive lever is provided at an end of the electromagnetic switch, and the drive lever is coupled to the motor shaft of the electric motor.
